(19) United States
(12) Patent Application Publication
(10) Pub. No.: US 2005/0048346 A1
(43) Pub. Date: Mar. 3, 2005

(54) Modular connections in a DMFC array

(76) Inventors: Megan A. Fannon, Latham, NY (US); Robert S. Hirsch, Troy, NY (US); Juan J. Becerra, Altamont, NY (US)

Correspondence Address: CESARI AND MCKENNA, LLP, 88 BLACK FALCON AVENUE, BOSTON, MA, 02210, US

(21) Appl. No.: 10/796,382

(22) Filed: Mar. 9, 2004

Related U.S. Application Data
(63) Continuation-in-part of application No. 10/650,424, filed on Aug. 28, 2003.

(51) Int. Cl. H01M 8/24; H01M 8/10

(52) U.S. Cl. 429/34; 429/32

(57) ABSTRACT

A modular DMFC array, and a related method of manufacturing such an array is provided. The modular DMFC array incorporates separately manufactured individual fuel cells that are connected after the manufacturing process. A locking mechanism incorporates the necessary electric connections. In one embodiment of the invention, the electrical connections also function as the locking mechanism. In such an embodiment, a separate mechanical fastening mechanism is not needed. In other embodiments of the invention, mechanical connections are provided to connect the individual fuel cells in the modular fuel cell array. Yet a further embodiment includes a carrier component on which the individual fuel cells are bonded. The electrical connections are provided either through the carrier component, or cell-to-cell.

### CROSS-REFERENCE TO RELATED APPLICATION

The present application is a continuation-in-part of commonly assigned copending U.S. patent application Ser. No. 10/650,424, which was filed on Aug. 28, 2003, by Megan A. Fannon et al. for a METHOD OF MANUFACTURING A FUEL CELL ARRAY AND A RELATED ARRAY and is hereby incorporated by reference.

### BACKGROUND OF THE INVENTION

1. Field of the Invention

This invention relates generally to fuel cells, and more particularly, to the manufacture of arrays of such fuel cells.

2. Background Information

Fuel cells are devices in which electrochemical reactions are used to generate electricity. A variety of materials may be suited for use as a fuel depending upon nature of the fuel cell. Organic materials, such as methanol or natural gas, are attractive fuel choices due to their high specific energy.

Fuel cell systems may be divided into “reformer-based” systems (i.e., those in which the fuel is processed in some fashion to extract hydrogen from the fuel before it is introduced into the fuel cell) or “direct oxidation” systems in which the fuel is fed directly into the cell without the need for separate internal or external processing. Most currently available fuel cells are reformer-based fuel cell systems. However, because fuel processing is complex, and requires expensive components, which occupy comparatively significant volume, the use of reformer based systems is presently limited to comparatively large, high power applications.

Direct oxidation fuel cell systems may be better suited for a number of applications in smaller mobile devices (e.g., mobile phones, handheld and laptop computers), as well as in some larger scale applications. In fuel cells of interest here, a carbonaceous fuel, typically methanol or an aqueous methanol solution, a vaporous methanol solution, or a combination thereof is introduced to the anode face of a membrane electrode assembly (MEA). The MEA contains a protonically conductive, but electronically non-conductive membrane (PCM). Typically, a catalyst, which enables direct oxidation of the fuel on the anode aspect of the PCM, is disposed on the surface of the PCM (or is otherwise present in the anode chamber of the fuel cell). In the fuel oxidation process at the anode, the products are protons, electrons and carbon dioxide. Protons (from hydrogen in the fuel and water molecules involved in the anodic reaction) are separated from the electrons. The protons migrate through the PCM, which is impermeable to the electrons. The electrons travel through an external circuit, which includes the load, and are united with the protons and oxygen molecules in the cathodic reaction, thus providing electrical power from the fuel cell.

One example of a direct oxidation fuel cell system is a direct methanol fuel cell system or DMFC system. In a DMFC system, a mixture comprised predominantly of methanol or a solution of methanol and water is used as fuel (the “fuel mixture”), and oxygen, preferably from ambient air, is used as the oxidizing agent. The fundamental reactions are the anodic oxidation of the methanol and water in the fuel mixture into CO₂, protons, and electrons; and the cathodic combination of protons, electrons and oxygen into water. The overall reaction may be limited by the failure of either of these reactions to proceed at an acceptable rate (more specifically, slow oxidation of the fuel mixture will limit the cathodic generation of water, and vice versa).

Direct methanol fuel cells are being commercially developed for use in portable electronic devices. Thus, the DMFC system, including the fuel cell and the other components should be fabricated using materials and processes that are not only compatible with appropriate form factors, but which are also cost effective. Furthermore, the manufacturing process associated with a given system should not be prohibitive in terms of associated labor or manufacturing cost or difficulty.

Typical DMFC systems include a fuel source, fluid and effluent management and air management systems, and a direct oxidation fuel cell (“fuel cell”). The fuel cell typically consists of a housing, hardware for current collection and fuel and air distribution, and a membrane electrode assembly (“MEA”) disposed within the housing.

A typical MEA includes a centrally disposed, protonically conductive, electronically non-conductive membrane (“PCM”). One example of a commercially available PCM is NAFION® a registered trademark of E.I. Dupont de Nemours and Company, a cation exchange membrane comprised of polyperflourosulfonic acid, in a variety of thicknesses and equivalent weights. The PCM is typically coated on each face with an electrocatalyst such as platinum, a platinum/ruthenium mixture or alloy particles. On either face of the catalyst coated PCM, the MEA typically includes a diffusion layer. The diffusion layer on the anode side is employed to evenly distribute the liquid fuel mixture across the anode face of the PCM, while allowing the gaseous product of the reaction, typically carbon dioxide, to move away from the anode face of the PCM. On the cathode side, a diffusion layer is used to achieve a supply and even distribution of gaseous oxygen across the cathode face of the PCM, while assisting with the management of water, a product of the cathodic reaction, and which may otherwise be present. Each of the anode and cathode diffusion layers also facilitate the collection and conduction of electric current from the reactions.

Fuel cell systems can be designed and manufactured in a variety of different configurations. Some fuel cell systems are based upon a single fuel cell. Others are based upon an array of fuel cells, which is a plurality of individual cells that are mechanically fastened together and which can be electrically connected either in series or parallel, depending upon the power requirements of the application device to be powered by the fuel cell system.

Particular challenges arise with respect to the successful manufacture of a fuel cell array, such as manufacturing such an array with efficiency and consistent high quality. More specifically, fuel cell arrays have been fabricated as a single unit. This involves manufacturing a single MEA by selecting a comparatively large sheet of the MEA materials, such as the NAFION® membrane, and sandwiching the NAFION® sheet between comparably-sized sheets of diffusion layer materials. Then, individual current collectors are connected across the MEA platform and cell-to-cell connections are made to thus create an array of individual fuel cells. An insert molding process is then employed to create a plastic frame around the fuel cells to seal the overall array. Details of a suitable insert molding process are provided in the parent application Ser. No. 10/650,424, from which this application is a continuation-in-part. The manufacture of a fuel cell array using the above-described single unit technique offers many benefits including the fact that minimal post processing is needed to prepare the array for assembly into a DMFC system. The system simply requires a fuel source for delivering fuel to the array, and electrical connections from the array to the application device to which power is to be provided.

Despite these conveniences, however, there are disadvantages associated with the single unit manufacturing process. For example, as noted above, the cell-to-cell electrical connections can be incorporated directly into the manufacturing process, but this makes it difficult to check the connections after the array is finished, particularly in the case of a injection molded cell because the cell-to-cell connections are located within a single plastic frame created around the fuel cells. If there is a short circuit or a broken connection, for example, or if one or more cells in the array fail to perform, the entire array fails. Thus, that entire array may have to be discarded, despite the fact that all but one of the fuel cells is functional.

The single MEA platform can also present challenges because of the sensitive nature of the materials and challenges of fabrication, causing a higher failure rate than is desirable. This failure rate might be within tolerances in the case of single cells, but an MEA platform that supports multiple fuel cells would contain a greater amount of materials. For example, the amount of material used in a six-cell array is six times that of a single cell. And, if the array MEA fails quality control inspection, then six times the material is wasted compared with wasting one failed single cell MEA. This also holds true for the other components of the fuel cell, such as the diffusion layers, current collectors and the plastic frame that has been injection molded around the array. In other words, a single failed cell in an array that is fabricated as single component could result in an entire failed array that, in turn, leads to wasted materials. As is known to those skilled in the art, these materials may be comparatively expensive and material yield must be maximized in a commercial manufacturing process. Another challenge in production of a membrane electrode assembly in an array configuration is that of dimensional consistency of the materials. For example, the PCM may expand or contract depending on the environmental conditions. There remains a need for a method of manufacturing a DMFC array that is simpler and lower cost compared with prior techniques and which allows for testing individual cells and removing those cells from the array in order to reduce waste, and which exhibits greater consistency in manufacturing outcomes. There remains a further need for a fuel cell array that includes interconnections between the fuel cells that have improved structural stability, flexibility, and reliable electrical connectivity.

It is an object of the invention to provide a method of manufacturing a fuel cell array in which individual cells can be tested before assembly and which is simple, less expensive, and which results in greater efficiency and lower cost, but a higher performance fuel cell system.

There is a further need for a fuel cell array that exhibits flexibility such that it can be used on non-planar surfaces, or on a surface that moves during use. One way to accomplish this is to have an electrical or mechanical connection that allows for movement of the array.

### SUMMARY OF THE INVENTION

These disadvantages are overcome by the present invention, which is a modular DMFC array and a related method of manufacturing such an array. The modular DMFC array incorporates separately manufactured individual fuel cells that are connected after the manufacturing process. Components that form the electrical connections between cells are incorporated into each cell and the electrical connections are made after the cells are manufactured. This prevents the connections from being affected during the fuel cell manufacturing process. It also allows the connections to be tested easily and individually, thus improving confidence in the quality of the electrical connections. Failed cells can be identified immediately and are not incorporated into the array. Alternatively, failed cells in an array can be replaced if post-assembly testing proves that the cell is inoperative.

Another feature of the modular DMFC array of the present invention is the ability to readily change the size and capacity of an array by simply adding or removing one or more cells. This allows for flexibility in design and testing and the ability to use the same design for several applications.

In accordance with the invention, the individual fuel cells are coupled together to form an array. A locking mechanism incorporates the necessary electric connections. There are a number of different types of electrical connections that are described in further detail herein. In one embodiment of the invention, the electrical connections also function as the locking mechanism. In such an embodiment, a separate mechanical fastening mechanism is not needed.

In another aspect of the invention, separate mechanical connections are provided to connect the individual fuel cells in the modular fuel cell array. These are interlocking features that fasten the individual fuel cells together. Such features are formed as a component along one edge of the fuel cell (i.e., the edge that contacts the adjacent fuel cell) and a complementary component is provided on the receiving edge of the adjacent fuel cell such that the two components interconnect and secure the adjacent fuel cells together. Many different implementations of those features can be designed and a number of examples are provided in further detail herein.

In accordance with another embodiment of the invention, the individual fuel cells of the modular DMFC array are attached to a carrier component that provides structural stability and allows for electrical conductivity. Said carrier component may be a rigid plate, or a flexible fabric or non-woven material. In the carrier embodiment, each cell has several tabs that protrude outwardly along one or more edges of the fuel cell which are bent downwardly and inserted into holes in the carrier component. The carrier component incorporates the desired electrical connections, and the tabs form the mechanical attachment. Appropriate openings and other features are provided for fuel delivery. A sealant may be applied between the fuel cell and the carrier for additional securement. Another carrier embodiment consists of cells attached to a carrier component by means of solvent bonding or other appropriate method. In this embodiment, the electrical connections are effected between cells (cell-to-cell), rather than through the carrier component itself.

In a third carrier embodiment, the cells are attached to one another mechanically by solvent bonding or otherwise. The electrical connections in this embodiment are formed through an appropriately designed circuit board that fits over tabs that protrude from each cell.

### BRIEF DESCRIPTION OF THE DRAWINGS

The invention description below refers to the accompanying drawings of which:

FIG. 1A is a top plan view of several individual fuel cells to be connected in accordance with the present invention;

FIG. 1B illustrates the cells of FIG. 1A assembled into an array;

FIG. 1C is an edge view of the assembled array of FIG. 1B;

FIG. 2A is a schematic illustration in which the electrical connections are used to create the mechanical connection between fuel cells in accordance with one embodiment of the invention;

FIG. 2B represents a plug and socket form of electrical connection in accordance with the present invention;

FIG. 2C illustrates the connection of FIG. 2B in a closed position;

FIG. 2D illustrates a spring tab connection in accordance with the present invention;

FIG. 2E illustrates the connection of FIG. 2D in a closed position;

FIG. 2F illustrates another electrical connection that includes interleaved metal tabs;

FIG. 2G illustrates the connection of FIG. 2F in a closed position;

FIG. 3A illustrates one embodiment of mechanical interlocking features of the present invention;

FIG. 3B is an alternative embodiment of interlocking features in accordance with the present invention;

FIG. 3C is an internal spring clip embodiment of the present invention;

FIG. 3D is an external spring clip embodiment of the present invention;

FIG. 3E is another embodiment in which a bead of plastic is formed along an edge to connect fuel cells in accordance with the present invention;

FIG. 4 illustrates an edge bracket connection of the present invention;

FIGS. 5A and 5B show a top plan view of an individual fuel cell and a plurality of fuel cells, respectively, that are placed on a carrier component in accordance with the present invention;

FIG. 5C illustrates an edge view of the array of FIG. 5B;

FIG. 6 is a schematic side section of the carrier embodiment of the present invention, in which electrical connections are made between cells; and

FIG. 7 illustrates the carrier embodiment of the present invention that includes a side-located circuit board.

### DETAILED DESCRIPTION OF AN ILLUSTRATIVE EMBODIMENT

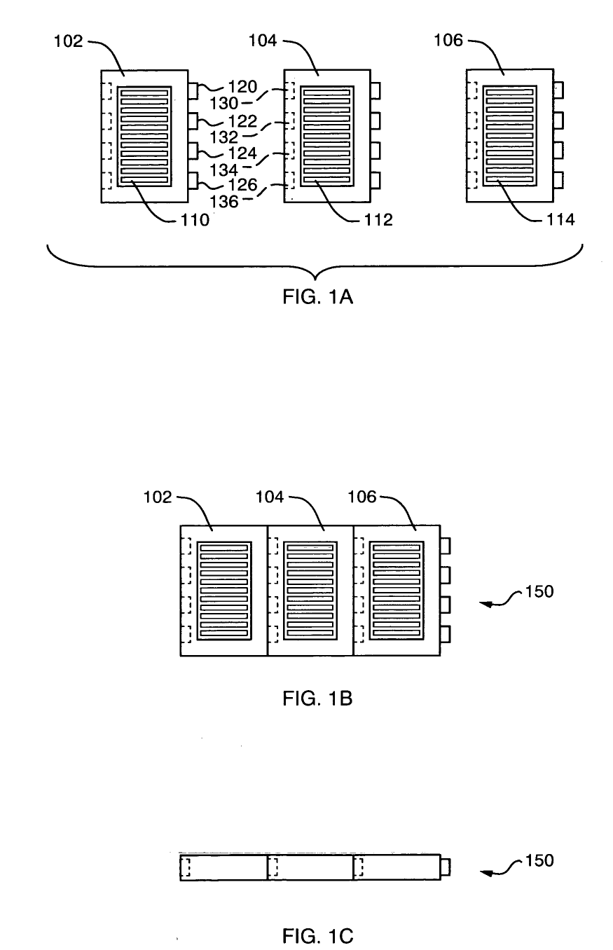

By way of background, FIG. 1A shows several individual fuel cells 102, 104 and 106. The fuel cells 102, 104 and 106 incorporate a membrane electrode assembly (not shown) as well as current collectors. In the top plan view of FIG. 1A, the anode current collectors 110, 112 and 114 of the fuel cells 102, 104 and 106, respectively, are visible. The individual fuel cells have a locking mechanism located along one edge thereof forming a first component of the locking mechanism. In FIG. 1A, the first components are tabs 120 through 126 (on the fuel cell 102). Each first component of the locking mechanism has a complementary receiving component that is disposed on the leading edge of the adjacent fuel cell. For example, in the illustration, the tabs 120 through 126 are received within slots 130 through 136 in the adjacent fuel cell 104. Similar tabs and slots are provided on the fuel cell 106 and any other fuel cells that are to be connected into the array.

Accordingly, the cells 102, 104 and 106 are assembled and connected into an array 150 as illustrated in FIG. 1B. An edge view of the assembled array 150 is illustrated in FIG. 1C. There are many possible designs for the locking mechanism that interconnect the individual fuel cells within the scope of the present invention. Examples of locking mechanism are described herein in detail for purposes of illustration, however, it should be understood that there are many different designs for such locking mechanisms that are within the scope of the present invention. These designs generally fall into two categories in accordance with the invention. Specifically, the first category involves a directly assembled array in which the individual cells are attached and secured to one another to form one unit. The second category includes a carrier structure onto which individual fuel cells are bonded.

Directly Assembled Arrays

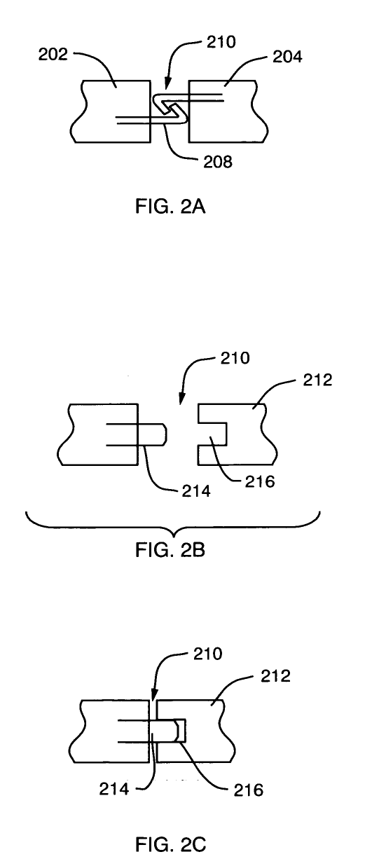

The directly assembled arrays, in accordance with the present invention, can be coupled together in a variety of ways. One manner in which the modular DMFC array of the present invention, such as the array 150 of FIG. 1B, can be connected is that the components that form the electrical connections between the individual cells 102, 104 and 106 also function as mechanical connections. As illustrated in FIG. 2A, cells 202 and 204 are to form a portion of a fuel cell array. The electrical lead 208 from the fuel cell 202 is passed through an appropriate coupling mechanism, generally designated as 210, to the adjacent fuel cell 204.

More specifically, one example of a type of electrical connection that can serve as the mechanical connection for the fuel cell array is illustrated in FIG. 2B. The fuel cell 210 is to be coupled with fuel cell 212. Fuel cell 210 is provided with a plug 214. The plug is coupled with the current collector (not shown) of the fuel cell 210 and it is comprised of a conductive material such as a metal. Plug 214 will typically be integrated with or fastened to the current collector and comprised of a compatible material. The adjacent fuel cell 212 incorporates a receiving component in the form of a socket 216, which is formed such that the plug 214 can be received therein to form a snug fit, but which also allows for electrical conductivity between the two fuel cells 210 and 212. The connected fuel cells are shown in FIG. 2C.

In accordance with another embodiment of the present invention, FIG. 2D illustrates the fuel cells 220 and 222, which are to be coupled together in an array. In this embodiment, the fuel cell 220 is provided with a spring tab 224. A corresponding spring tab 226 is provided on the adjacent fuel cell 222. When fuel cells 220 and 222 are pressed together, or otherwise connected, spring tabs 224 and 226 contact each other and both spring tabs compress to form an electrical connection. There may be additional features incorporated into this embodiment, or other embodiments, that act to protect the electrical connection, such as an insulator, from the operating environment. It may be further desirable to enhance the electrical or mechanical connection by using a plastic enclosure such as a “shrink wrap” that provides a level of compression and protection for the connections.

In yet another embodiment of the invention, FIG. 2F illustrates an interleaved connection in which a first set of metal tabs 240 on a first fuel cell (not shown) correspond with a second set of metal tabs 242 on an adjacent fuel cell (not shown). When interconnected as shown in FIG. 2G, the metal tabs 240 are interleaved with and slide over the metal tabs 242 to form a friction fit. The friction fit provides a tight connection that serves as the mechanical coupling between the two adjacent fuel cells while the metal tabs provide for electrical conductivity between the adjacent fuel cells. In this manner, the electrical connections also provide the mechanical interlocking mechanism to couple the two adjacent fuel cells together in a directly assembled cell-to-cell array.

Another electrical connection, in accordance with the present invention, that is not separately illustrated but which could be incorporated into any of the others shown, is the direct spot welding of tabs of nickel or other metal from the cathode of one cell to the anode of the next cell. For example, as illustrated in FIG. 1A, the tab 120 could be spot welded onto a similar tab in the area of the slot 130 of the adjacent fuel cell 104.

There may be other electrical connections that can be made between adjacent individual fuel cells to form a modular DMFC array for directly assembling the cell-to-cell connections while remaining within the scope of the present invention, but which are not specifically mentioned herein. Furthermore, it should be understood that not all cells will include two electrical connection components because there may be a leading edge cell at one end of the array, and an opposite edge cell on the other end, and these edge cells do not require both components for electrical connection, but such edge cells are still within the scope of the present invention. In the directly assembled cell-to-cell arrays, there are many possibilities for mechanical connections between cells. Many of them involve features, which connect the edges of adjacent fuel cells. The connections ideally are secure connections. In some instances, though the connection is secure, it may be desirable that the connection allows for flexibility so that the array of fuel cells itself can be employed in a variety of shapes that are not necessarily planar. A conformable fuel cell was described in commonly owned U.S. patent application Ser. No. ______: [Atty. Docket No.: 107044-0043] by Gottesfeld et al., filed on Mar. 2, 2004 for a CONFORMABLE FUEL CELL, which is incorporated herein by reference.

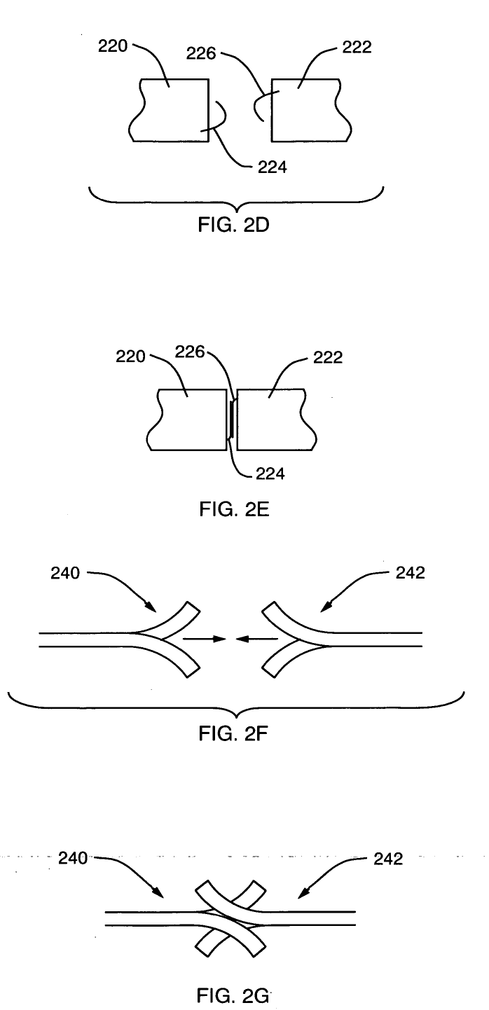

In certain instances, conventional electrical connections may be employed, and it is still desirable to establish a mechanical connection between individual fuel cells in an array. Examples of interlocking features that can be used to mechanically interconnect individual fuel cells to create an array are illustrated as follows. FIG. 3A illustrates a fuel cell edge portion 302 coupled to an adjacent fuel cell portion 304. The fuel cell portion 302 has an interconnecting feature 306 that corresponds with a receiving feature 308 in the fuel cell portion 304 interlocking the adjacent fuel cells to form the array.

Similarly, FIG. 3B illustrates fuel cell portion 310 and fuel cell portion 312 that include another type of interlocking mechanism in which the rounded feature 314 interconnects with a corresponding feature 316 in the adjacent fuel cell 312. As will be understood by those skilled in the art, such features can be pre-molded into any suitable shape that causes a snap fit or interlock to form a secure attachment between fuel cells.

FIG. 3C illustrates another embodiment in which an internal spring clip 320 is used to mechanically connect fuel cells 324 and 326. More specifically, the fuel cell portion 324 includes a slot or other suitable opening 330. Fuel cell portion 326 also includes a slot or other suitable opening 332. The spring clip 320 slides into the pre-molded slots 330 and 332 in the edges of the cells 324 and 326 mechanically connecting adjacent cells.

Another embodiment of the invention is illustrated in FIG. 3D. In this embodiment the adjacent fuel cells 324 and 326 include an external spring clip 340. In the embodiment of FIG. 3D, the fuel cell 324 includes grooves, impressions or other features, such as grooves 344a and 344b. Similarly, the fuel cell portion 326 includes similar grooves, impressions or other features, such as grooves 348a and 348b. The spring clip assembly 340 has a first external fastening member 350, which is received within the groove 344a and which couples to the groove 348a in the adjacent fuel cell 326. Similarly, a second spring clip attachment member 352 couples the groove 344b to the groove 348b. Thus, the adjacent fuel cells 324 and 326 are mechanically fastened together to create the array.

A further embodiment of the invention is illustrated in FIG. 3E. In this embodiment, a fuel cell 360 is to be mechanically coupled to an adjacent fuel cell 362. In this example, fuel cell 360 has tab 364, which is received within the slot 366. In the embodiment of FIG. 3E, a bead of plastic is welded along the entire edge contact between the cells. After an electrical connection is established by placing tab 364 in slot 366, a bead of plastic is welded along one or more contact edges between the cells.

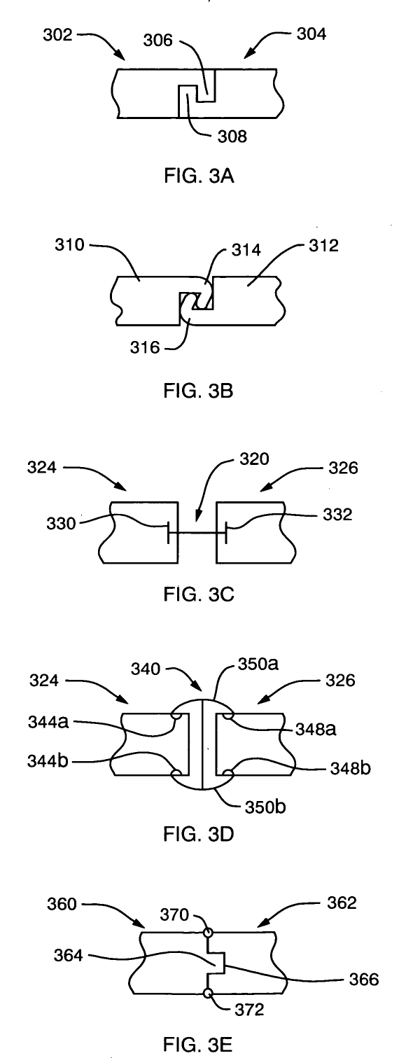

Yet a further mechanical connection is illustrated in FIG. 4. The array 400 of FIG. 4 includes individual fuel cells 402 through 410. Two or more individual fuel cells 402-410 are attached to bracket 420, and electrically connected where appropriate. The bracket may be formed from common metals or polymers depending on the desired application. Bracket 420 is designed to mechanically couple more than one fuel cell. Where additional stability is desired, a second bracket 422 may be attached to one or more of the individual fuel cells 402-410.

In combination with any of the above-described interlocking mechanisms, it may be necessary or desirable to incorporate solvents or other bonding materials for securing the plastic frames together. Alternatively, an application of an epoxy or other sealant may aid in mechanical stability and sealing against leaks.

Carrier Embodiment

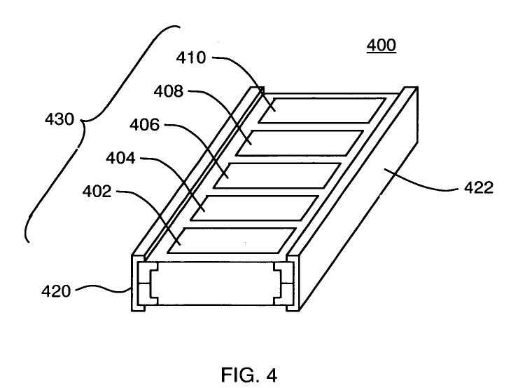

As noted herein above, another category of modular DMFC arrays incorporates individual fuel cells that fit in or attach to a type of underlying carrier component that provides structural stability and/or electrical conductivity. The carrier can be a rigid plate, such as an appropriate plastic or fiberglass plate, or it may be a pliable material, such as a fabric or non-woven material. Though illustrated herein as being planar, a rigid carrier component may take any number of shapes as is necessary or desirable for a particular application including, but not limited to a curvilinear form. By way of background, FIG. 5A illustrates an individual fuel cell 500 that is one building block of an array such as the array 550 of FIG. 5B. The array 550 of FIG. 5B includes the fuel cells 504 through 508. The fuel cells 504 through 508 are attached to a carrier component 560. Multiple cells in the carrier 560 are illustrated in FIG. 5C. In order to attach the fuel cells 504 through 508 to the carrier 560, the fuel cells are manufactured with several tabs such as the tabs 562 through 566 on the fuel cell 504. These tabs, such as the tabs 562 through 566, are located on one or more edges of the rectangular fuel cell 504 and each tab can be bent toward the carrier to form legs on the fuel cell. These legs 562 are then inserted into holes (not shown) in a carrier 560 to create the modular DMFC array. The carrier 560 also may incorporate the designed electrical connections. The tabs form the mechanical attachment. Carrier 560 also includes appropriate openings for reactant introduction and product removal, as well as being designed to provide for an anode vapor gap should a vapor fuel be employed. Further details of vaporous fuel delivery are provided in commonly owned U.S. patent application Ser. No. 10/413,983, filed by Ren et al., on Apr. 15, 2003, for a DIRECT OXIDATION FUEL CELL OPERATING WITH DIRECT FEED OF CONCENTRATED FUEL UNDER PASSIVE WATER MANAGEMENT, which is incorporated herein by reference.

It may also be necessary or desirable in the embodiment illustrated in FIG. 5B to use a sealant between the individual fuel cells 504, 506, 508, etc. and the carrier 560.

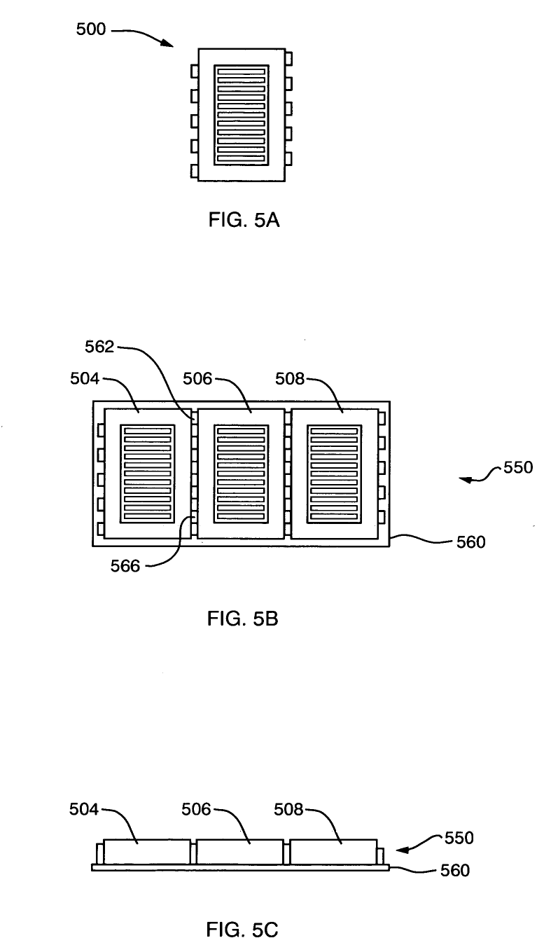

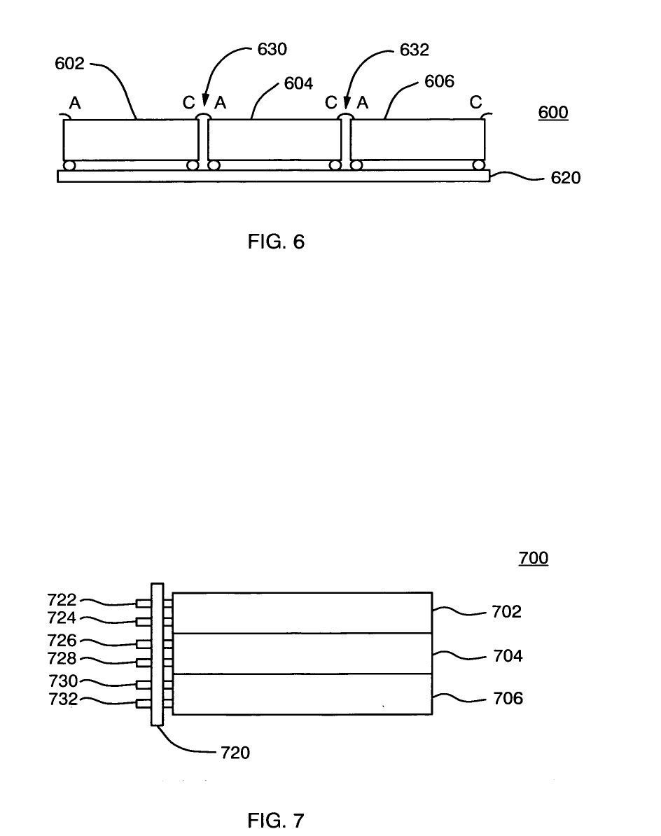

FIG. 6 illustrates another embodiment of the invention in which a fuel cell array 600 is comprised of individual fuel cells 602, 604 and 606 when attached to a carrier 620 by means of a solvent bonding or other appropriate method, but the electrical connections such as the connection 630 and 632 are employed between cells, rather than through the carrier 620 itself. More specifically, an electrical connection 630 is made from the cathode of the fuel cell 602 to the anode of the adjacent fuel cell 604. The electrical connection itself could be one of the electrical connections that are described herein, or another suitable electrical connection known to those skilled in the art. In accordance with another aspect of the invention, the carrier component also acts as a protective covering for the electrical and/or mechanical connections. In such a case, at least a portion of the carrier component may be substantially comprised of a fabric, such as treated nylon, carbon cloth or other suitable material that provides protection for the connections from the operating environment. FIG. 7 illustrates a fuel cell array 700 that comprises individual fuel cell 702, 704 and 706 that are attached to a circuit board or other appropriately designed carrier 720. In this carrier embodiment, the cells 702, 704 and 706 are attached to one another mechanically, which may include any of the aspects mentioned in FIGS. 3A through 3E, for example, or by solvent bonding. The electrical connection, however, is formed through the circuit board 720 that fits over the tabs in the fuel cells. For example, the tabs 722 and 724 are provided in the fuel cell 702. The tabs 726 and 728 are provided in fuel cell 704 and the tabs 730 and 732 are provided in fuel cell 706. These tabs are coupled to the side located circuit board 720. By doing so, it is possible to connect the individual fuel cells in parallel or in series, depending on the power needs of the application device.

It should be understood that the present invention provides a novel modular DMFC array and methods of manufacturing such an array in which individual fuel cells can be tested prior to assembly. In this manner, cells that do not meet quality control expectations or requirements can be discarded without the need to discard the entire fuel cell array. This reduces wasted materials, lowers manufacturing costs and cuts down manufacturing time. The present invention also provides for an array that has more robust electrical connections than known arrays. Furthermore, the ability to add or remove fuel cells gives rise to flexibility in array size and performance designs. Furthermore, the array itself can be incorporated into non-planar fuel cell design environments.

The foregoing description has been directed to specific embodiments of the invention. It will be apparent, however, that other variations and modifications may be made to the described embodiments, with the attainment of some or all of the advantages of such. Therefore, it is the object of the appended claims to cover all such variations and modifications as come within the true spirit and scope of the invention.

1. A modular direct oxidation fuel cell array, comprising:
a plurality of individual direct oxidation fuel cells, each fuel cell having a membrane electrode assembly and an anode current collector and a cathode current collector, each fuel cell having a first electrical coupling component disposed thereon and a second electrical coupling component disposed in a different location on said fuel cell, which second component corresponds with a first component of an adjacent cell to electrically and/or mechanically couple the cells together, to form a modular fuel cell array.

2. The modular direct oxidation fuel cell array as defined in claim 1 wherein said first electrical coupling component is a plug member, and said second electrical coupling component is a socket wherein adjacent fuel cells are connected by a plug-and-socket configuration.

3. The modular direct oxidation fuel cell array as defined in claim 1 wherein said first electrical coupling component is a spring tab member, and said second electrical coupling component is a second spring tab member wherein adjacent fuel cells are connected by compression of said first and second spring tab members between adjacent cells.

4. The modular direct oxidation fuel cell array as defined in claim 1 wherein said first electrical coupling component is a set of interleaved metal tabs, and said second electrical coupling component is a second set of interleaving metals tabs, wherein adjacent fuel cells are connected by interlocking said first and second metal tabs of adjacent cells together.

5. The modular direct oxidation fuel cell array as defined in claim 1 wherein said first and second coupling components are substantially surrounded by a protective covering.

6. A modular direct oxidation fuel cell array, comprising:
a plurality of individual direct oxidation fuel cells, each fuel cell having:
(i) a membrane electrode assembly and an anode current collector and a cathode current collector;
(ii) a mechanical coupling assembly including a first mechanical coupling component disposed thereon, and a corresponding second mechanical coupling component disposed at another location, which second mechanical coupling component corresponds with a first component of an adjacent cell to fasten the fuel cell to an adjacent fuel cell; and
(iii) an electrical connection between each of said plurality of fuel cells, to form a modular fuel cell array.

7. The modular direct oxidation fuel cell array as defined in claim 6 further comprising
said first mechanical coupling component being a contoured flange portion extending from one edge of said fuel cell, and said second mechanical coupling component being a corresponding contoured recess disposed at an opposite edge such that the flange portion on a fuel cell is compressed into said recess of an adjacent fuel cell to mechanically couple adjacent fuel cells together.

8. The modular direct oxidation fuel cell array as defined in claim 7 wherein said contoured flange has a smooth, curvilinear shape, and said recess has a corresponding smooth, curvilinear shape.

9. The modular direct oxidation fuel cell array as defined in claim 6 wherein said mechanical coupling assembly comprises an internal spring clip.

10. The modular direct oxidation fuel cell array as defined in claim 6 wherein said mechanical coupling assembly comprises an external spring clip.

11. The modular direct oxidation fuel cell array as defined in claim 6 wherein said mechanical coupling assembly includes a plastic bead welded onto one aspect of the fuel cell to connect it to an adjacent fuel cell.

12. A modular direct oxidation fuel cell array, comprising:
(A) a plurality of individual direct oxidation fuel cells, each fuel cell having:
(i) a membrane electrode assembly and an anode current collector and a cathode current collector;
(ii) a locking mechanism located on each fuel cell to secure that fuel cell to an adjacent fuel cell;
(iii) an electrical connection for making electrical contact between each of said plurality of fuel cells;
(B) a carrier component onto which each fuel cell of said plurality of fuel cells is secured, forming a modular fuel cell array.

13. The modular direct oxidation fuel cell array as defined in claim 12 wherein said carrier component is substantially comprised of at least one of a rigid plate, or of a substantially pliable material.

14. The modular direct oxidation fuel cell array as defined in claim 12 wherein said carrier component is contoured to a desired shape which shape includes a non-planar and/or curvilinear shape.

15. The modular direct oxidation fuel cell array as defined in claim 12 wherein said individual fuel cells further include tabs that are received within corresponding slot on said carrier component.

16. The modular direct oxidation fuel cell array as defined in claim 12 wherein said electrical connections between individual fuel cells are made within said carrier component.

17. The modular direct oxidation fuel cell array as defined in claim 12 wherein said carrier component includes a circuit board.

18. A method of manufacturing a modular direct oxidation fuel cell array, including the steps of:
manufacturing a plurality of individual fuel cells;
connecting said fuel cells together electrically from the cathode of one cell to the anode of an adjacent cell; and
mechanically securing the fuel cells together to form a fuel cell array.

19. A direct oxidation fuel cell for use in a modular fuel cell array, comprising:
(A) a membrane electrode assembly and an anode current collector and a cathode current collector;
(B) at least one locking mechanism located on the fuel cell to secure that fuel cell to an adjacent fuel cell; and
(C) at least one electrical connection element for making electrical contact with an adjacent fuel cell.

20. The direct oxidation fuel cell for use in a modular fuel cell array, as defined in claim 19 wherein said fuel cell is an edge cell that includes a locking component, and an electrical connection element for connection to an adjacent fuel cell, but does not have a locking component or an electrical connection element on a side which represents one end of the fuel cell array.

21. A connection assembly for use with a modular fuel cell array, comprising:
an electrical connection assembly having a first element disposed on a first fuel cell, and an second element disposed on an adjacent fuel cell to electrically couple said fuel cells together.

22. The connection assembly as defined in claim 21 further comprising:
a mechanical connection assembly having a first element disposed on a first fuel cell, and an second element disposed on an adjacent fuel cell to mechanically couple said fuel cells together.
